(19) United States
(12) Patent Application Publication
(10) Pub. No.: US 2025/0033901 A1
(43) Pub. Date: Jan. 30, 2025

(54) AUTOMATED LIFTING DEVICE COMPRISING A BOOSTER VALVE

(71) Applicant: COBOT LIFT APS, Slagelse (DK)

(72) Inventor: Flemming Bischoff Truelsen, Slagelse (DK)

(21) Appl. No.: 18/713,954

(22) PCT Filed: Nov. 29, 2022
(86) PCT No.: PCT/EP2022/083598

§ 371 Date: May 28, 2024

(30) Foreign Application Priority Data
Nov. 29, 2021 (DK) PA202101132

(51) Int. Cl. B65G 47/91

(52) U.S. Cl. CPC B65G 47/91

(57) ABSTRACT

A hoisting tube (12) is attached to a suction pad (5) having an inner volume and an edge providing an air-tight closure to a surface of an object during operation. A vacuum source subjects the hoisting tube (12) to a low pressure, and the inner volume of the hoisting tube (12) is connected to the inner volume of the suction pad (5) in such a way that air may flow from one to the other, the vacuum source providing a lifting force when air flowing into the hoisting tube (12) is limited or cut-off. A valve unit (14) includes a separator (15) that in one position reduces an airflow between the inner volumes of the hoisting tube (12) and the suction pad (5) and in at least one open position allows a maximum airflow therebetween. The valve unit (14) includes an actuator (6) for controlling the position of the separator.

### TECHNICAL FIELD OF THE INVENTION

The present invention relates to a lifting device for lifting and vertically, and possibly horizontally, replacing an object. The lifting device comprises a first unit configured with one or more catching parts such as suction pads and a second unit configured to control vertical and optionally horizontal position of the object.

### BACKGROUND OF THE INVENTION

EPO493979 (A1) discloses a traditional vacuum lifting/hoisting device where the expansion or contraction of a variable length bellows-like lift tube is controlled by controlling the vacuum level within the lift tube, which level is in turn controlled by a user operable valve to connect and/or isolate the interior of the lift tube to atmosphere. Thus, in a fully open valve position, the lift tube interior is open to atmosphere, the vacuum within the lift tube is destroyed and, with the tube hanging vertically from a suspension point, the lift tube falls to its maximum expanded length. Conversely, in a fully closed valve position, the vacuum is at a maximum and the tube rises to its maximum contracted position-being in use a maximum lift height. It follows that intermediate opening of the valve achieves an intermediate position. A device according to EPO493979 (A1) discloses a vacuum lifting/lowering head 12 comprising a fixed upper handle 2 adapted to be gripped by one hand 3 of a user 4. The head 12 also comprises a movable lower handle 7 suitable for one hand manual operation. A triangular opening 10 is provided in a part of the head 12, and a correspondingly triangular valve member 11 in the form of a simple cover plate is attached to lower handle 7 and displaceable by the user's movement of the lower handle 7. With the opening 10 completely closed off by valve member 11, a maximum vacuum level exists within the lift tube 23, which therefore contracts, bellows-like, to its minimum length bringing the vacuum lifting head to its maximum height. Hence, the first requirement is for the user to lower the head 12 until it engages an article 18 to be lifted, relocated and then lowered. Thus, with the palm of the user's hand 3 gripping the fixed handle 2 the user's fingers, directed downwardly, engage and push downwardly on the lower movable handle 7. This exposes the aperture 10, destroys the vacuum within the lift tube 23 by an in-rush of atmospheric air through the opening 10 exceeding the evacuation capacity of the associated vacuum pump, until the lifting head 12 suspended by the lift tube 23, contacts the article 18 under the guidance of the user by suitably manoeuvring the fixed handle 2. Then, an upward pull on the movable handle 7 partially closes off the opening 10 to re-establish a vacuum within both the lift tube 23 and lifting head 12. With partial opening of the opening 10 by the valve member 11, to an extent controlled by the user, the article 18 is gripped and is in a hover mode, at a user-controllable height. With further upward movement by the user on the movable handle 7, the opening 10 is completely closed off by the valve member 11 and the article 18 may be raised to maximum height and relocated. It follows that in the re-located position, partial exposure of the opening 10 by user-control of the valve member 11 lowers the lift head 12 and article 18, while full exposure releases an article 18 that has previously been lifted, moved and lowered.

WO2007094720 discloses a vacuum hoisting device with a vertical hoisting tube suspended at an upper end and connected to a vacuum source adapted to be switched on and off, which tube at a lower end is provided with a suction foot and a positioning handle secured to the suction foot for manoeuvring the suction foot, and a manually operated valve device for permitting admission of air to the hoisting tube such that the hoisting tube is axially extensible and contractible in dependence on the air pressure prevailing in the hoisting tube. The device comprises a tubular positioning handle and constitutes an oblique, downwards directed connection between the interior of the hoisting tube and the interior of the suction foot, and provided with an outside, axially slidingly mounted grip sleeve positioned between an upper and a lower end position, the grip sleeve is connected to the manually operated valve device by a connecting means and when the grip sleeve is slided towards its lower end position against the action of a spring then the valve device is forced to open. Without actuation of the grip sleeve the valve device is closed and with working suction source the suction foot is kept hanging immovable or is slowly lifted to an upper lift position depending on the trimming of the vacuum hoisting device. When the grip sleeve is slided downwards, the valve device is opened and air flows into the hoisting tube, the vacuum in hoisting tube is reduced and the suction foot is lowered. After the suction foot has been positioned on an object the grip sleeve can be slided upwards so that the valve device assisted by the spring force acting on the valve device is closed, and the object is sucked firmly to the suction foot and by this is lifted upwards when the hoisting tube starts contracting due to the increasing vacuum inside the hoisting tube.

WO 21/110843 relates to a lifting device for lifting and vertically, and possibly horizontally, replacing an object. The lifting device comprises a first unit configured with one or more catching parts such as suction pads and a second unit configured to control vertical and optionally horizontal position of the object. The lifting device comprises a first unit (1) and a second unit (2), the first unit (1) is configured to catch and/or hold an object and provide power for moving the object in a vertical direction, and the second unit (2) is configured to control a vertical position of the object, wherein the first unit (1) comprises: a stationary vertically extending part (3), a horizontally extending part (4) and a lifting part (12) such as a hoisting tube comprising a first and a second attachment position, at the first attachment position the lifting part (12) is attached or fixed to the horizontally extending part (4) and at the second attachment position the lifting part (12) is attached or fixed to a longitudinal member (11), the longitudinal member (11) comprises a catching part (5) such as a suction pad. A sliding member (10) is configured to slide in two directions between a first and a second end position along the longitudinal member (11), and the actual position of the sliding member (10) relative to the longitudinal member (11) is configured to determine the lifting power of the lifting part (12). The second unit (2) comprises a first attachment position and a second attachment position where the first attachment position is fixed to the vertically extending part (3) of the first unit (1) and the second attachment position is fixed to the sliding member (10) of the first unit (1) by a rigid joint configured to transfer all movements induced at the second attachment position by the second unit (2) to the sliding member (10). This lifting device may also comprise a valve (14) comprising a plate (15) which valve (14) may provide separation between an inner space and vacuum of a hoisting tube (12) and the inner space and vacuum of the suction pad(s) (5), the valve (14) functions by sliding the plate (15) between a forward and a backward position. However, the opening of this valve (14) and the position of the plate (15) must be fixed before a lifting operation, it is not possible to maneuver the valve during a lifting operation. The opening of the valve (14) i.e. the position of the plate (15) is used to adapt the pressure to the surface of the specific objects to be moved in order to reduce noise and energy consumption during use.

### SUMMARY OF THE INVENTION

The purpose of the present invention is to provide a lifting device having benefits in respect of improved control of the automated lifting device. By making it possible to open and close the valve during operation, it is possible to further vary the suction during operation and thereby support the vacuum control exercised by a primary vacuum control unit such as a sliding member (10) configured to slide in two directions between a first and a second end position along a longitudinal member (11), where the actual position of the sliding member (10) relative to the longitudinal member (11) is configured to determine the lifting power of the lifting part (12).

### Dictionary

In general—features described by these words in the context of the present document may be used in one or all embodiments of the invention as defined in the specification or in the claims.

Fix, fixed, fixedly—two parts being fixed to each other means that the two parts cannot be released from each other without destroying the parts, the parts may be considered permanently attached to each other.

Air—the word “air” may generally be replaced with the word “gas” i.e. it is the functionality of air as a gas i.e. a fluid tending to expand indefinitely, which is relevant in connection with the present document, not the composition as such.

### BRIEF DESCRIPTION OF THE FIGURES

FIG. 1 discloses an embodiment of lifting part according to prior art as disclosed in WO 21/110843.

FIG. 2 discloses a cut-through view of a valve unit.

FIG. 3 discloses an exploded view of a valve unit.

### DETAILED DESCRIPTION OF THE INVENTION

In the detailed description of the invention units having same or similar function in different embodiments have same reference number.

In general, the present invention relates to a lifting device or hoisting device with similar functionality as described in respect of the prior art, where a vacuum lifting tube during operation is subjected to a continuous low pressure by a pump, and an opening in the lifting tube determines the pressure inside the lifting tube and whether an object is lifted, lowered or kept at a constant height.

A lifting device according to the present invention may be applied for lifting all kind of objects comprising a smooth surface to which a suction pad may engage with a vacuum, e.g. the objects may be bags, sacks, buckets, barrels, packages, boxes or the like. The lifting device according to the present invention may be advantageously applied when lifting objects having a softer or more flexible outer surface such as bags or sacks or the like.

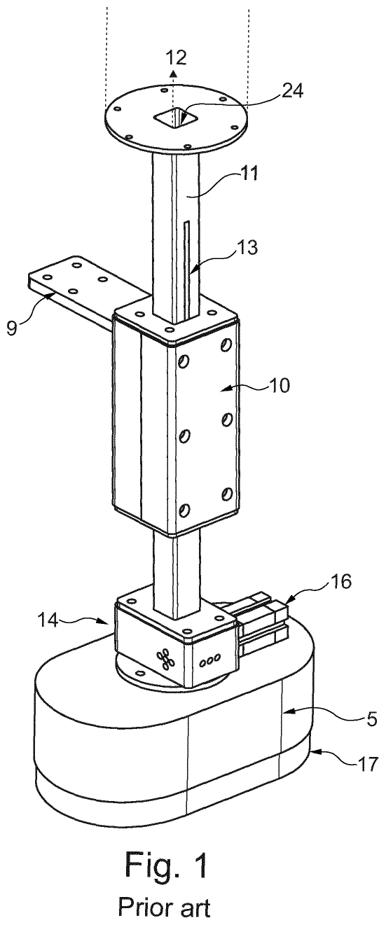

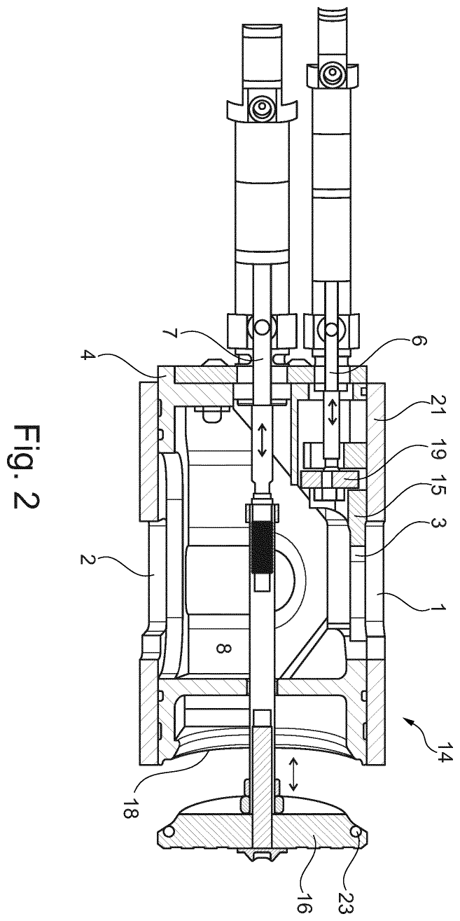

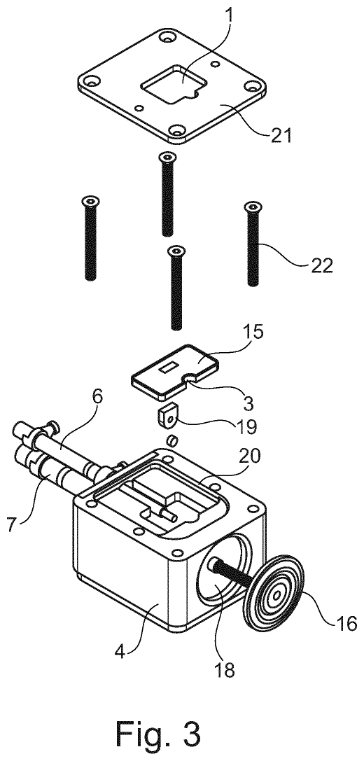

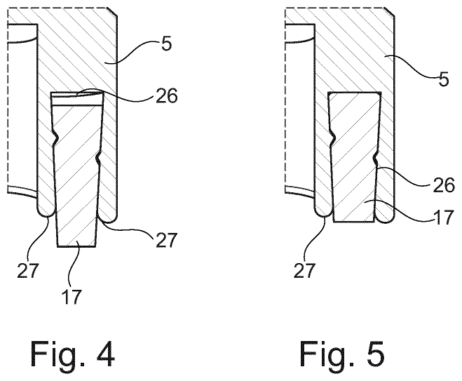

FIG. 1 shows an enlargement of part of a lifting device known from prior art. This lifting device comprises a suction pad 5 attached to a longitudinal member 11 comprising a central opening 24. The lifting device also comprise a valve 14 which may provide a separation between an inner space and a vacuum of the hoisting tube 12 and the inner space or vacuum of the suction pad 5. The valve 14 in FIG. 1 is shaped as a box positioned between a sliding member 10 and the suction pad 5 and when the valve 14 is closed it is possible to maintain a low pressure inside the hoisting tube 12 without an object being attached to the suction pad 5. The valve 14 is located just above the suction cup 5. The valve 14 comprises a so-called drop-off valve (not shown in FIG. 1). The drop-off valve 16, which is best seen in FIG. 3, can equalize the pressure between the interior of the suction cup and the surrounding atmosphere. When this happens, the suction cup 5 will lose its load-bearing capacity and accordingly, the drop-off valve is therefore used to release products from the suction cup. A disadvantage of this is that when a product is released, the pressure in both the longitudinal member 12 and the hoisting tube 12 will fall correspondingly, and thus the hoisting tube 11 will lose its lifting capacity. Typically, the hosting tube will fall (collapse) down on the just released product. To prevent this, the valve 14 comprises a throttle valve having a plate 15 which can cover the opening of the valve towards the lower part 30 of the longitudinal member 11.

The plate 15 may slide into a closed position where the plate 15 covers the opening. The plate 15 may also slide into an open position. The plate 15 may be in all positions between these two end positions allowing detailed control of the air-intake through the opening 25 between the longitudinal member 11 and the suction pad 5.

As best seen in FIG. 3 the plate 15 comprises a cut-out/opening. This opening prevents the plate 15 from completely blocking the air flow between valve 14 and the lower part 30 of the longitudinal member 11 thus preventing the suction cup 15 from unintentionally releasing a thereto attached product when the plate is moved to its closed position.

The minimum opening is under lifting operation used when the suction cup is used to lift products which comprise surfaces that forms very tight joints between the suction cup and the products. The reduced opening defined by the cut-out entails that the pressure is not fully equalized between the suction cup and the hoisting tube when the release valve is opened 16 and collapse of the hoisting tube 12 when releasing a product is thus prevented.

In cases where the system is used to lift products that have a surface that does not form a tight joint between the suction cup and the product, it may be necessary to regulate the suction force in the system to compensate for this. According to an embodiment of the invention this is achieved by open the throttle valve so that it allows a greater air flow between valve 14 and the lower part of longitudinal member 30.

The size of the opening determined by the position of the plate 15 is determined before a lifting operation takes place and is used to adapt the suction to the surface of the object to be moved, and the size of the opening defined by the plate 15 is adapted to reduce noise and energy consumption during operation.

According to the invention it is realized that the regulating mechanism 15, 20, may be used to quickly achieve tight connection between the product to be lifted and the suction cup 5.

In an embodiment of the invention this is done by connecting the plate 15 to an actuator 6. The actuator 6 may be adapted such that an operator can activate it and thereby regulate the size of the opening between the lower part of the longitudinal member 30 and the valve 14. However, the actuator 6 may also be connected to a computer-controlled controller in order to achieve a computer controlled lifting process. The idea underlaying the actuator-operated plate 15 is to displace the plate 15 in order to expand or fully open the opening 25 when the suction cup is above (in the immediate vicinity, usually less than 25 cm from) a workpiece to be lifted. When the opening 25 is expanded, an increased air flow will flow through the suction cup and at the same time the pressure in the hoisting tube 12 will drop. When pressure in the hoisting tube falls, the hoisting tube will lengthen, and the suction cup will move towards the workpiece and hit this while there is an increased air flow through the suction cup.

This will entail a quickly and reliably fasten of the workpiece to the suction cup and as soon as this happens, the pressure in the hoisting tube 12 will drop and accordingly, lifting power commence. When the workpiece is sucked onto the suction cup, the air flow through the valve 14 will be reduced, and accordingly, the requirements for an expanded opening 20 are reduced or eliminated. The operator or computer can therefore activate the actuator to move the plate towards a more closed position. This more closed position is normally maintained until the lift is completed and the product is released by the operator or the computer activating the actuator to open the release valve. As the plate 15 occupies the more closed position where the air flow through the valve is throttled by the plate, the internal pressure in the tube 12 will not fall correspondingly to the pressure in the suction cup 5. The suction cup can therefore be held up while it is moved to a new workpiece, where the actuator 6 is activated to open the opening 25, and the process is repeated.

FIG. 2 discloses a cut-through view of an embodiment of a valve unit 14 of a lifting device according to the invention.

In general, the valve unit 14 is during operation positioned between the hoisting tube 12 and the suction pad 5, and the valve unit 14 has an inner opening 8, an upper opening 1 through which air may flow between the valve unit 14 and the inner volume of the hoisting tube 12 and a lower opening 2 through which air may flow between the valve unit 14 and inner volume of the suction pad 5. The valve unit 14 may also comprise a drop-off valve 16 and an opening 18 through which opening 18 an airflow may pass if the drop-off valve is activated. If the drop-off valve 16 is not activated the drop-off valve 16 will block the opening 18 and prevent air flowing the opening 18.

The valve unit 14 comprises a separator in form of a plate 15 which may be moved between two positions, an open position allowing a maximum airflow and a closed position allowing a minimum airflow. In FIG. 2 the plate 15 is shown in the open position allowing a maximum air flow between the valve unit 14 and the hoisting tube 12.

The plate 15 may comprise small opening 3 allowing a minimum air flow between the hoisting tube 12 and the valve unit 14 when the plate 15 is in closed position. Alternatively, the small opening 3 may appear due to as a slit between an edge of plate 15 and an edge of the upper opening 1, or as several smaller openings.

The valve unit 14 shown in FIG. 2 comprises a housing 4. The housing 4 provides easy installation of the parts of the valve unit 14 as the parts may be fixed and/or connected to the housing 4 whereafter the housing 4 can be positioned between the hoisting tube 12 and the suction pad 5 in such a way that air flowing between the hoisting tube 12 and the suction pad 5 flows through the valve unit 14.

In general, the separator 15 may slide back and forth between an open position where the separator 15 does not or at least minimally blocks an airway between the suction pad 5 and the hoisting tube 12, and a closed position where the separator 15 blocks the airway maximally between the suction pad 5 and the hoisting tube 12. According to the embodiment of the valve unit 14 shown in FIG. 2, the separator 15 is shaped as a rectangular plate 15 comprising a semi-circular opening 3 in the front edge.

In general, the separator 15 comprises fastening means 19 fixing and/or connecting the separator 15 to the actuator 6. According to the embodiment of FIG. 2, the separator or plate 15 comprises an opening corresponding to fastening means 19 connected to the actuator 6, which fastening means 19 is in the form of locking plate fastened to a movable end of the actuator 6.

In general, the valve unit 14 comprises guiding means for guiding the separator 15 in a precise way between the open and the closed position. According to the embodiment of FIG. 2, the guiding means comprises an opening 20 in the upper wall of the housing 4 combined with a cover plate 21 between which the plate 15 can only move in two directions-back and forth along a straight line. During operation or after manufacturing the valve unit 14, the cover plate 21 is fastened to the housing 4 by fastening means 22 e.g. in form of screws.

The drop-off valve 16 may also move between an open and a closed position, however, the drop-off valve 16 normally have only two positions, an open and a closed position. Either the drop-off valve 16 is completely open and air may flow freely in and out of the opening 18, or the drop-off valve 16 is completely closed in which position air cannot pass through the opening 18. To assure that no air pass through the opening 18 in the closed position, the drop-off valve 16 comprises a sealing in form of a sealing ring 23. According to the embodiment of FIG. 2, the drop-off valve 16 may be forced back and forth along the arrows between the open and closed position.

The actuators 6 and 7 for the separator 15 and for the drop-off valve 16 may be of any available type. FIG. 3 discloses an exploded view of an embodiment of a valve unit 14 of a lifting device according to the invention. FIG. 3

### Operation of Lifting Device

The length of the hoisting tube 12 is determined by the size of the pressure inside the hoisting tube 12, the lower the pressure the shorter is the hoisting tube 12 and the higher is an object attached to the suction pad 5 lifted. Both according to prior art lifting devices and lifting devices according to the invention, the pressure inside the hoisting tube 12 is controlled by an external and not shown vacuum source.

During a lifting procedure with a prior art hoisting tube, the pressure is first reduced in the hoisting tube 12 causing the hoisting tube 12 to shorten and thereby lifting the suction pad 5 attached to the lower end of the hoisting tube 12 to a position above the object to be lifted. When the suction pad 5 is in position above the object to be lifted, the pressure inside the hoisting tube 12 is increased either by controlling the inlet of air to the hoisting tube 12 e.g. through a valve 13 being opened, or by controlling the pressure delivered by the vacuum source. The increase in pressure inside the hoisting tube 12 will increase the length of the hoisting tube 12 and therefore lower the suction pad 5 down to the object to be lifted. When the suction pad 5 reaches the object to be lifted, the surface of the object blocks the air flow through the suction pad 5 and the pressure inside the hoisting tube 12 is therefore reduced as the vacuum source lowers the pressure inside the hoisting tube 12. The object is then lifted as the valve 13 is closed. The object may then be moved to a new position hanging from the suction pad 5 and at the new position lowered and released from the suction pad 5 e.g. by activating the drop-off valve 16.

During a lifting procedure, using a lifting device according to the invention, the pressure is first reduced in the hoisting tube 12 to shorten and thereby lifting the suction pad 5 attached to the lower end of the hoisting tube 12. The suction pad is then moved to a position above the object to be lifted. During lifting of the suction pad 5 without an object attached, the separator 15 is normally moved towards the closed position. This will reduce the energy needed to maintain a necessary low pressure inside the hoisting tube 12 and the suction power is accordingly reduced. When the suction pad 5 is positioned above the object to be lifted, the separator 15 may be moved to a maximum open position which increases the pressure inside the hoisting tube 12 and makes the suction pad 5 “fall down” on the object to be lifted. The fall in combination with greater airflow caused by the open separator 15 normally provides a strong hold by the suction pad 5 on the object. The object is then lifted by controlling the valve 13 or a similar valve. The opening of the separator 15 may be adjusted e.g. by an automatic control, during the lift. When the suction pad reaches the object, the opening of the separator 15 may again be partly closed to avoid that the hoisting tube 12 continue to expand in length.

As shown in FIG. 1, the suction cup 5 is preferably provided with a rubber lip 17. The rubber lip 17 may be mounted in a groove/recess provided in the sides of the suction cup 5.

The extra force by with which the suction cup 5 strikes (falls down on) an object to be lifted when the separator 15 is used as explained above causes an increased wear on the rubber lip 17. This is especially relevant when the suction cup 5 is used to lift multifaceted objects such as suitcases/luggage at an airport. These objects will often have a surface that varies from area to area on the individual object and the suction cup may therefore “fall down” on hard dents which may ruin the rubber lip. This may be the case, for example, if a soft bag contains hard objects that bulge out. This may also be the case if the bags include zippers.

Accordingly, the lip thus needs faster replacement.

In one embodiment of the invention as shown in FIGS. 4 and 5, this increased wear is prevented by making the rubber lip 17 of an elastic material and mutually adapting the rubber lip to the recess 26 such that the rubber lip 17 can be completely or partially deformed into the recess as shown in FIGS. 4 and 5.

As also seen in FIGS. 4 and 5, the recesses 26 in these embodiments are made with rounded edges 27. This further prevents the rubber lip from being damaged against the edges 27 when the rubber lip is pressed against the recess 26.

By adapting the recess and rubber lip to each other, it is achieved so that the very edge of the suction cup absorbs the forces that occur when the suction cup “falls down” on e.g. a local elevation/edge of objects.

### LIST OF REFERENCE NUMBERS

1 Upper opening
2 Lower opening
3 Minimum opening allowing a minimum air flow through separator 15
4 Housing of valve unit
5 Catching part e.g. suction pad
6 Actuator for separator
7 Actuator for drop-off valve7
8 Inner volume of valve unit
9 Control member or handle for control member
10 Slidable member
11 Longitudinal member
12 Lifting part e.g. hoisting tube
13 Valve opening such as an opening in 11
14 Valve unit
15 Separator late inside valve unit 14
16 Drop-off valve
17 Rubber or foam lip
18 Opening for drop-off valve
19 Fastening means fastening separator to actuator 6
20 Guiding means guiding separator 15 relative to housing 4
21 Cover plate
22 Fastening means for cover plate
23 Sealing for drop-off valve 16
24 Central opening of 11
25 Opening between longitudinal member and suction pad 5
26 Recess/groove

1. A lifting device comprising a hoisting tube (12) connected to an adjustable vacuum source, wherein the hoisting tube (12) is attached or fixed to a suction pad (5) comprising an inner volume and an edge providing an air-tight closure to a surface of an object during operation,
the vacuum source for subjecting the hoisting tube (12) to a low pressure, wherein an inner volume of the hoisting tube (12) is connected to the inner volume of the suction pad (5) in such a way that air is flowable therebetween, the vacuum source for providing a lifting force when air flowing into the hoisting tube (12) is limited or cut-off, wherein
the lifting device further comprises a valve unit (14) comprising a separator (15) which in at least one position reduces an airflow between the inner volume of the hoisting tube (12) and the inner volume of the suction pad (5) and in at least one open position allows a maximum airflow between the inner volume of the hoisting tube (12) and the inner volume of the suction pad (5),
wherein the valve unit (14) further comprises an actuator (6) controlling the position of the separator (15) during operation between an open position allowing a maximum airflow and a closed position allowing a minimum airflow through the valve unit (14).

2. The lifting device according to claim 1, wherein the valve unit (14) comprises a housing (4) comprising an upper opening (1), a lower opening (2) and an inner volume (8), for flowing air between the hoisting tube (12) and the suction pad (5) during operation.

3. The lifting device according to claim 1, wherein the separator (15) is constituted of a plate.

4. The lifting device according to claim 1, wherein the valve unit (14) comprises guiding means (20, 21) for guiding the separator (15) along a straight line between the open and the closed position.

5. The lifting device according to claim to claim 1, wherein the hoisting tube (12) is attached or fixed to a first end of a longitudinal member (11), wherein at a second end the longitudinal member (11) is attached or fixed to the valve unit (14), wherein a sliding member (10) is configured to slide in two directions between the first end of the longitudinal member and the second end of the longitudinal member along the longitudinal member (11), wherein an actual position of the sliding member (10) relative to the longitudinal member (11) determines a lifting power.

6. The lifting device according to claim 1, wherein the longitudinal member (11) comprises a central opening (24) for passing forced air, the longitudinal member (11) configured with a valve opening (13) extending in a longitudinal direction of a wall of the longitudinal member (11), the valve opening (13) for allowing air to flow to and from the central opening (24) and the surroundings, the valve opening (13) configured so that the valve opening (13) is covered by the sliding member (10) when the sliding member is at the first end of the longitudinal member whereas the valve opening (13) is not covered or only partly covered by the sliding member (10) when the sliding member (10) is at the second end of the longitudinal member.

7. The lifting device according to claim 1, wherein the suction pad (5) comprises a flexible or elastic lip (17) providing an air-tight closure against a surface of a liftable object.

8. The lifting device according to claim 7, wherein the flexible or elastic lip (17) is positioned in a groove (26) extending around a perimeter of the suction pad (5).

9. The lifting device according to claim 8, wherein the lip (17) of the suction pad (5) is sufficiently flexible so that when subjected to pressure is forced into the groove (26).

10. The lifting device according to claim 8, wherein the lip (17) and the groove in the suction pad (26) are mutually adapted so that the lip is forced under elastic deformation so far into the groove (26) of the suction pad (5) that a pressure difference that occurs between the liftable object and the suction pad essentially occurs between the suction pad and the object when the object is attached to the suction pad by means of the pressure difference.

11. A method for lifting and moving an object with a lifting device according to claim 7, comprising:
generating a pressure in the hoisting tube that is lower than ambient pressure;
controlling a height of the suction pad by regulating pressure inside the hoisting tube;
moving the suction pad into a position above the liftable object;
activating the actuator such that the separator is moved towards the open position and thereby controlling the pressure inside the suction tube such that the suction pad is lowered onto the liftable object for attaching the object to the suction pad;
lifting the object by controlling the pressure inside the hoisting tube, and
moving the liftable object by moving the suction pad.

12. The method for lifting and moving an object with a lifting device according to claim 11, further comprising activating the actuator and moving the separator towards the closed position while moving the liftable object.

13. The method for lifting and moving an object with a lifting device according to claim 11, further comprising regulating the pressure inside the hoisting tube to keep the object attached to the suction pad while moving the liftable object.
